(19) United States
(12) Patent Application Publication
(10) Pub. No.: US 2008/0216454 A1
(43) Pub. Date: Sep. 11, 2008

(54) Horse blanket

(76) Inventors: Sean Lacow, Boca Raton, FL (US); Adam Day, Boynton Beach, FL (US); Maureen Carroll, Atlanta, GA (US)

Correspondence Address: Sunbeam Products, Inc., 2381 Executive Center Drive, Boca Raton, FL, 33431, US

(21) Appl. No.: 11/715,516

(22) Filed: Mar. 7, 2007

(51) Int. Cl. B68C 5/00

(52) U.S. Cl. 54/79.2; 54/79.1

(57) ABSTRACT

A blanket for covering a four-legged, tailed animal includes a main panel configured for draping over the animal's back and defining a rear edge adjacent the animal's tail. The blanket also provides a chest panel connected to and underlying the main panel and configured to be wrapped around the animal's chest and neck. The chest panel includes a pair of expansion gussets for enhancement of the flexibility and fit of the chest panel about the animal's chest and neck. Finally, the blanket provides an elastically biased tail flap attached to the underside of and extending downward from the rear edge of the main panel.

### BACKGROUND OF THE INVENTION

1. Field of the Invention

The present invention relates to a horse blanket. More particularly, the present invention is directed to a specialty blanket, commonly referred to as a turnout blanket, used by equestrians to keep a horse's body temperature elevated during extended periods of exposure to cold when they are “turned out” to pasture.

2. Description of the Related Art

Conventional horse blankets are provided to protect a horse from mud, dirt, and moisture, and to provide a degree of thermal insulation. These conventional horse blankets typically conform to the shape of a horse's upper body to provide adequate protection from the elements and some measure of comfort. An additional purpose for the use of such blankets is to maintain the horse's temperature in an elevated state. By elevating a horse's temperature, the natural growth of hair, for insulation purposes, is retarded and the animal does not require clipping in addition to regular grooming. As such, turnout blankets, in particular, are used by equestrians to keep a horse's body temperature elevated during extended periods of exposure to the cold, for instance when they are “turned out” to pasture and when they are kept in unheated or exposed stables.

The conventional construction of these prior art blankets provides for a conforming fit to the animal's upper body, including a tight fit around the neck. One result of this fitted design is the binding and misalignment of the blanket due to repeated raising and lowering of the horse's head and neck. Further, the use of an ill-fitting or misaligned turnout blanket can often cause sores and hair loss at friction points where the animal's movement is restricted by the blanket. One such area of concern is found on the chest, being that part of the animal where its front legs meet the base of the front of its neck. Blanket manufacturers have attempted to minimize these sores and occurrences of hair loss by either over-sizing the blanket, resulting in a poorly fit blanket which fails to adequately protect the animal or through the addition of one or more gussets. The gussets sole purpose is to provide additional material in a localized fashion, thus over-sizing the garment without distorting the overall fit.

Additionally, tail flaps are commonly utilized on horse turnout blankets to provide protection to the animal's hind quarters and tail from the elements. However, if the tail flap is either lifted by a gust of wind or does not remain situated in the proper orientation, it is not effective. Tail flaps of the prior art are prone to being lifted by wind gusts, as well as becoming generally misaligned due to the movement of the blanket as a whole either due to a poor fit or repeated raising or lowering of the animal's head and neck as discussed above. Further, they have heretofore been found inconsistent in their ability to become properly repositioned after the wind subsides or after the normal shifting and repositioning of the blanket as the animal moves around.

As with other friction points on the prior art blankets, tail flaps of the prior art have been found to be prone to causing tail hair wear or are often restrictive during the excrement process of the animal. Companies such as Weatherbeeta have developed tail flaps that have addressed gust prevention by over sizing the tail flap and providing a full gusset attachment down either side of the tail flap. This not only restricts the animal, in particular its tail movement, but it also adds significant material to the blanket.

### SUMMARY OF THE INVENTION

Disclosed herein is a horse turnout blanket having improvements in the chest and tail areas which address the above-described deficiencies of the prior art.

In accordance with one embodiment of the present invention, the fit and flexibility of the blanket in the chest area is improved, thus causing minimal restriction to the horse's movement and improving the blanket's fit that would be otherwise compromised by excessive material. By increasing mobility and maintaining a flexible form, the chances of wear and sores to the animal is reduced, while simultaneously reducing the risk of snagging excessive fabric as is found in prior art turnout blankets. Still further, there is a corresponding reduction in movement and misalignment of the blanket resulting solely from the movement of the animal.

The attachment point of the tail flap may be positioned in such a relationship to the main panel of the blanket to provide sufficient support against the upward forces on the lifting flap, over-lifting of the flap, and excessive exposure of the horse to the elements during wind gusts. In order to achieve the minimization of wind effects, the attachment point of the blanket may be positioned forward of and under the rear edge of the blanket's main panel. Such positioning adequately aligns the tail flap without creating unnecessary wear and friction on the animal's tail or restricting the animal's ability to raise its tail.

Improvement of the tail flap's resistance to external forces while retaining and even improving fit and function may be achieved by the inclusion of elastic gussets in the form of triangular pieces of elasticized fabric, such as Lycra® fabric or other similar exterior circular knot fabrics made of polyester.

### BRIEF DESCRIPTION OF THE DRAWINGS

The organization and manner of the structure and function of the present invention, together with further aspects and advantages thereof, may be understood by reference to the following description taken in connection with the accompanying drawings, wherein like reference numerals identify like elements, corresponding parts and/or features and in which:

FIG. 1 is a left side view of a horse blanket in accordance with a preferred embodiment of the present invention fitted to a horse;

FIG. 2 is a top view of the horse blanket in accordance with the present invention;

FIG. 3 is a bottom view of the horse blanket of FIG. 2;

FIG. 4 is a front view of the horse blanket of FIG. 1 fitted to a horse; and

FIG. 5 is a rear view of the horse blanket of FIG. 1 fitted to a horse.

### DETAILED DESCRIPTION OF THE PREFERRED EMBODIMENT

While the present invention may be susceptible to embodiment in different forms, there are shown in the drawings, and herein will be described in detail, embodiments with the understanding that the present description is to be considered an exemplification of the principles of the invention and is not intended to limit the invention to that as illustrated and described herein. Instead, it is envisioned that those skilled in the art may devise various modifications and equivalents without departing from the spirit and scope of the appended claims.

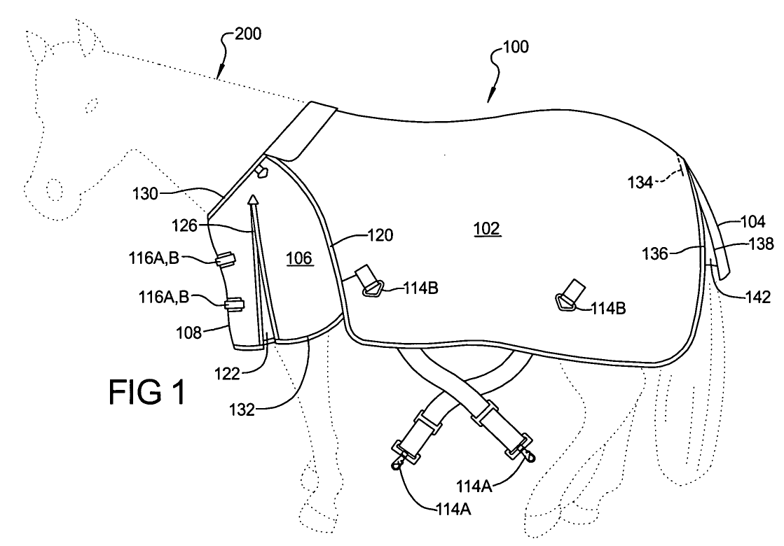

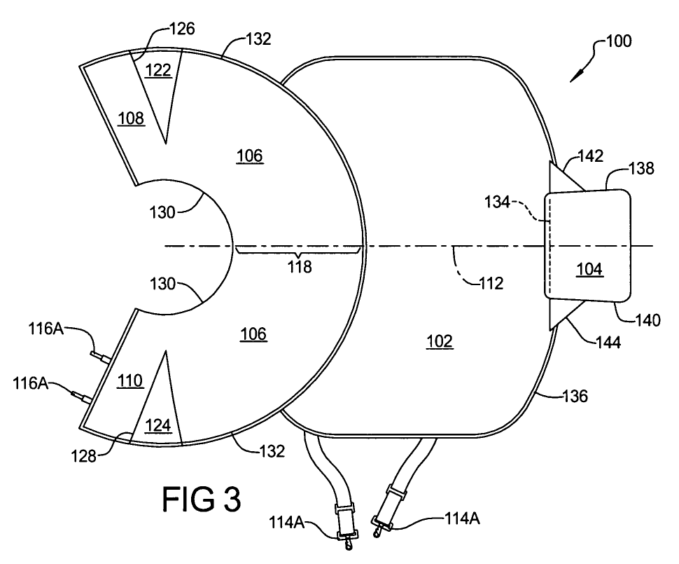

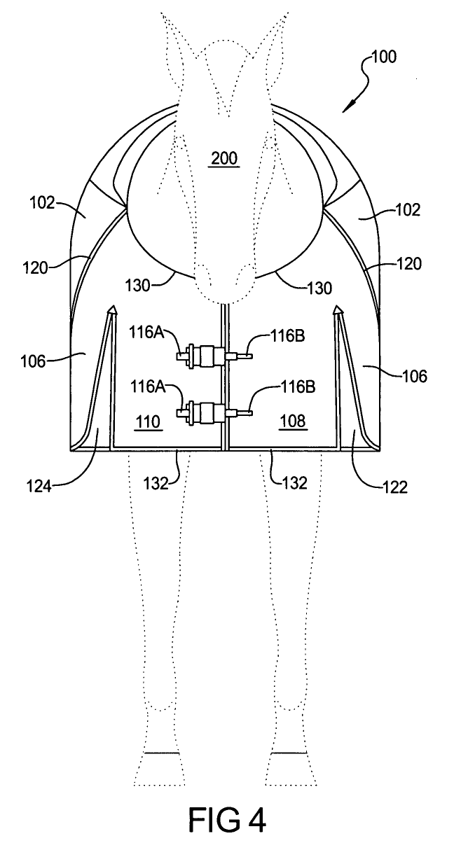

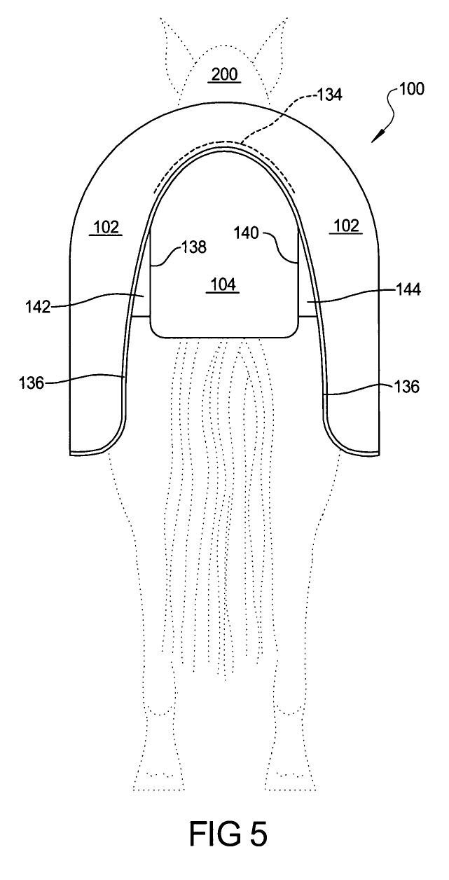

Referring to FIGS. 1-5, a horse turnout blanket 100 according to a preferred embodiment of the present invention is shown. The blanket 100 includes a main panel 102, a tail flap 104, and a chest panel 106, consisting of a left chest flap 108 and a right chest flap 110. These components are preferably made of a durable and flexible material capable of providing some insulation to the animal against the elements.

In dressing a horse 200 with the blanket 100, the main panel 102 is draped over the back of the horse so the main panel's longitudinal centerline 112 is disposed over and along the animal's spine. Cross-straps 114A are then passed under and across the horse's midsection and connected to buckles 114B to secure the blanket to the animal. The left and right chest panels 108 and 110, respectively, are pulled forward and wrapped around the animal's chest and joined together to cover and protect the chest with the use of straps 116A and buckles 116B.

It should be noted that chest panel strap assemblies 116A and 116B, as well as cross strap assemblies 114A and 114B, may be any known securing means sufficient to maintain the user established fit of the blanket 100. By way of example and not limitation, such alternative securing means may include, but are not limited to, snaps, ties, snap-lock fasteners or hook and loop fasteners.

Chest panel 106 is joined to main panel 102, preferably by stitching, only at a stitch line 118 along and adjacent to the longitudinal centerline 112. Other known means of joining the fabric panels together along this line may be used, such as gluing, or even by removeably connecting the panels with a releasable securing means as discussed above. Other than along the stitch line 118, the chest panel 106 is not affixed to the main panel 102. This allows for an increased independence of movement between the two panels 102 and 106 as the horse's front legs move during periods of activity. Additionally, such increased independent movement has been found to increase comfort for the horse 200 while simultaneously reducing wear to both the blanket 100 and the horse 200.

The main panel 102 and chest panels 108 and 110 are overlapped. Preferably, the main panel 102 lays outside of the chest panel 106, in relation to the horse 200, at least along that portion of the blanket 100 that extends from the longitudinal centerline 112 to the front edge 120 of the main panel 102. The chest panel 106 includes a vertical left gusset 122 and a vertical right gusset 124 corresponding to and associated with the fixed ends 126 and 128 of the left and right chest panels 108 and 110, respectively. These gussets 122 and 124 are preferably located adjacent the horse's left and right forelegs to allow for additional freedom of movement by the horse 200. The extent of each gusset 122 and 124 runs from just below the top edge 130 of the chest panel 106 through the panel's bottom edge 132.

It should be noted that while the gussets 122 and 124 may be formed in any of the generally known methods, they are preferably formed by sewing the additional material into place and maintaining the pre-formed folds in the material with edge bindings.

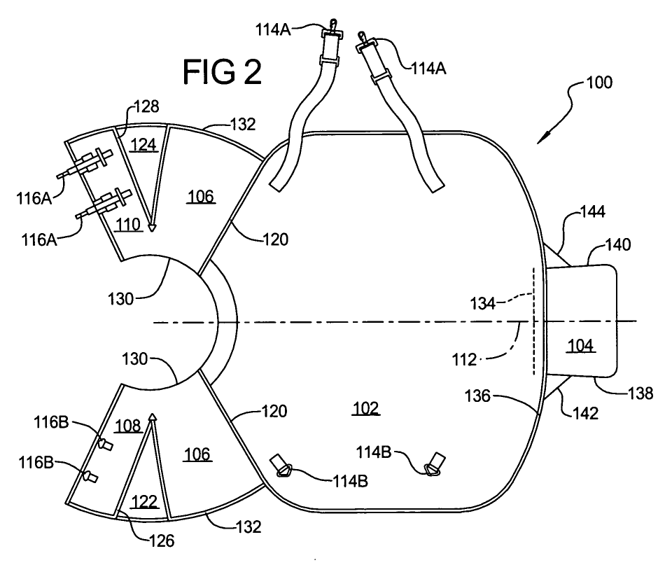

As best seen in FIGS. 2, 3, and 5, tail flap 104 is overlapped by the main panel 102. Preferably, the main panel 102 lays outside of the tail flap 104, in relation to the horse 200. In particular, it is preferred that the tail flap 104 is affixed to the underside of the main panel 102 along a stitch line 134 which is disposed parallel to and several inches removed from the rear edge 136 of the main panel 102. In particular, it is preferred that the stitch line 134 lie generally between about one to five inches forward of the rear edge 136 of the main panel 102. With such a structure, the weight of the main panel 102 serves to provide a downward force on the section of the tail flap 104 extending beneath the main panel 102. This downward force, in combination with the general stiffness of the durable, insulating material used in the construction of the blanket 100, generally, has been found to be sufficient to resist over-lifting of the tail flap 104 during wind gusts.

The side edges 138 and 140 of tail flap 104 are connected to a portion of the rear edge 136 of the main panel 102 with generally triangular elastic fabric panels 142 and 144. The triangular panels 142 and 144 are preferably secured to the underside of both the main panel 102 and the tail flap 104 to provide an additional downward bias for retaining the tail flap 104 from a wind- or movement-induced misalignment. The triangular elastic panels 142 and 144 preferably comprise a circular knit fabric, such as, but not limited to Lycra® fabric, that will allow for movement of the horse 200 without interfering with the positioning of the tail flap 104 or the blanket 100, in general.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

1. A blanket for covering a four-legged animal comprising:
a main panel configured for draping over the animal's back and defining a forward edge disposed generally alongside the animal's forelegs, a longitudinal centerline disposed along the animal's spine, and a rearward edge disposed generally alongside the animal's tail;
a chest panel affixed to said main panel along a portion of the longitudinal centerline and extending beyond the forward edge of the main panel, the chest panel configured to wrap around the animal's neck, wherein the free ends of the chest panel comprise a pair of opposing overlaying portions suitable for adjusting the fit of the blanket about the neck of the animal; and
a generally rectangular tail flap secured generally along a line parallel to the rearward edge of the main panel.

2. The blanket of claim 1 wherein one of the main panel and the chest panel overlay the other about and forward of their affixation along a portion of the longitudinal centerline.

3. The blanket of claim 1 wherein the pair of opposing overlaying portions comprises a right flap for covering the animal's right shoulder and a left flap for covering the animal's left shoulder, wherein the right and left flaps are configured to be overlapped and selectively secured together to adjust the fit of the blanket about the neck of the animal.

4. The blanket of claim 3 wherein each of the right and left flaps include a gusset generally disposed alongside the animal's foreleg.

5. The blanket of claim 3 wherein the right and left flaps are selectively secured using a securing means selected from the group consisting of: strap and buckles, snaps, ties, hook and loop fasteners, and snap-lock fasteners.

6. The blanket of claim 1 wherein the tail flap is elastically biased against the animal's tail.

7. The blanket of claim 6 wherein elastic bias is provided by a pair of opposing, generally triangular elastic panels, wherein each of the elastic panels is secured along a first edge generally parallel to the rearward edge of the main panel and laterally disposed from the line of connection between the tail flap and the main panel and wherein each of said elastic panels is secured along a second edge generally perpendicular to the line of connection between the tail flap and the main panel.

8. The blanket of claim 1 wherein the line of attachment of the tail flap is generally about one to five inches forward of the rearward edge of the main panel.

9. A horse blanket for assisting in protecting the horse's coat from the elements, including mud, dirt, moisture, and the cold, the blanket comprising:
a main panel configured to be draped laterally over the horse's back and defining a leading edge, a trailing edge, and a longitudinal centerline disposed generally along the animal's spine;
a chest panel affixed to the main panel only along a portion of the longitudinal centerline, the chest panel suited to be wrapped around the horse's neck and protect the animal's chest; and
an elastically-biased tail flap secured to and extending from the trailing edge of the main panel, the tail flap configured to protect the horse's hindquarters and tail.

10. The blanket of claim 9 wherein one of the main panel and chest panel overlay the other about and forward of their affixation.

11. The blanket of claim 10 wherein the chest panel further comprises a left overlaying portion and a right overlaying portion, wherein each of the overlaying portions is suited for being selectively secured to the other to adjust the fit of the blanket about the horse's neck.

12. The blanket of claim 11 wherein each of the right and left flaps include an expandable gusset generally disposed alongside the animal's foreleg to enhance the adjustability and fit of the blanket about the animal's neck.

13. The blanket of claim 9 wherein the main panel further comprises a pair of securing means for securing the main panel about the midsection of the horse.

14. The blanket of claim 9 wherein the elastic bias of the tail flap is provided by a pair of opposing, generally triangular elastic panels, wherein each of the elastic panels is secured along a first edge generally parallel to the rearward edge of the main panel and wherein each of said elastic panels is secured along a second edge generally perpendicular to the rearward edge of the main panel.

15. The blanket of claim 9 wherein the line of attachment of the tail flap is generally about one to five inches forward of the rearward edge of the main panel.

16. A method of protecting the coat of a horse from the elements, comprising the steps of:
draping a blanket across the horse's body, wherein the blanket comprises:
a main panel defining a leading edge, a trailing edge, and a longitudinal centerline disposed generally along the animal's spine;
a chest panel affixed to the main panel along a portion of the longitudinal centerline; and
a tail flap secured to and extending from the trailing edge of the main panel;
securing the blanket about the midsection of the horse using a pair of securing means affixed to the main panel and suited for passage under the horse's belly;
adjusting the chest panel about the horse's neck, wherein the chest panel includes a pair of opposed overlaying portions each having a gusset therein to enhance the flexibility and fit of the chest panel; and
selectively securing the ends of the opposed overlaying portions of the chest panel to each other.

17. The method of claim 16 wherein one of the main panel and the chest panel overlay the other about and forward of their affixation.

18. The method of claim 17 wherein the main panel securing means and the means for selectively securing the pair of opposed overlaying portions are individually selected from the group consisting of: strap and buckles, snaps, ties, hook and loop fasteners, and snap-lock fasteners.

19. The method of claim 16 wherein the tail flap is elastically biased against the horse's tail.

20. The method of claim 19 wherein the elastic bias is provided by a pair of opposing, generally triangular elastic panels, wherein each of the elastic panels is secured along a first edge generally parallel to the rearward edge of the main panel and wherein each of said elastic panels is secured along a second edge generally perpendicular to the line of connection between the tail flap and the main panel.
